(19) United States
(12) Patent Application Publication
(10) Pub. No.: US 2026/0220208 A1
(43) Pub. Date: Jul. 30, 2026

(54) VERSION CONTROL FOR STRUCTURED NETWORK CONFIGURATION DATA

(71) Applicant: Cisco Technology, Inc., San Jose, CA (US)

(72) Inventors: Naveen Kumar TYAGI, Fremont, CA (US); Khanh V. NGUYEN, MILPITAS, CA (US); Aniruddh S. DIKHIT, San Jose, CA (US)

(21) Appl. No.: 19/036,830

(22) Filed: Jan. 24, 2025

(51) Int. Cl. G06F 16/93

(52) U.S. Cl. CPC G06F 16/93

(57) ABSTRACT

In one embodiment, an illustrative method herein comprises: decomposing a primary document composed of structured data into a plurality of subdocuments corresponding to atomic units of the structured data; storing, when the primary document is an initially committed version of the primary document, the primary document as a referenced collection of the plurality of subdocuments each uniquely identified and having an associated version; comparing, when the primary document is an updated version of the primary document, each of the plurality of subdocuments with its own previous version to determine whether there is a difference; storing, for subdocuments where there is a difference, a corresponding updated subdocument version to be referenced for the updated version of the primary document; and establishing, for subdocuments where there is no difference, a reference to a corresponding previously stored subdocument version for the updated version of the primary document.

### TECHNICAL FIELD

The present disclosure relates generally to computer networks, and, more particularly, to version control for structured network configuration data.

### BACKGROUND

Computer systems, such as enterprise networks, are becoming more complex and dynamic, and configuration data is growing in size and complexity, accordingly. For example, a wireless controller device today may have more than two million configuration parameters organized in complex structures of interconnected model objects that change frequently as the networks adapt to dynamic loads and environments.

Managing and tracking configuration changes in such large and dynamic computer networks has become a pressing need, but management tools in this regard are generally lacking. In particular, existing version control systems such as git are not suitable for structured data such as network and device configurations.

### BRIEF DESCRIPTION OF THE DRA WINGS

The embodiments herein may be better understood by referring to the following description in conjunction with the accompanying drawings in which like reference numerals indicate identically or functionally similar elements, of which:

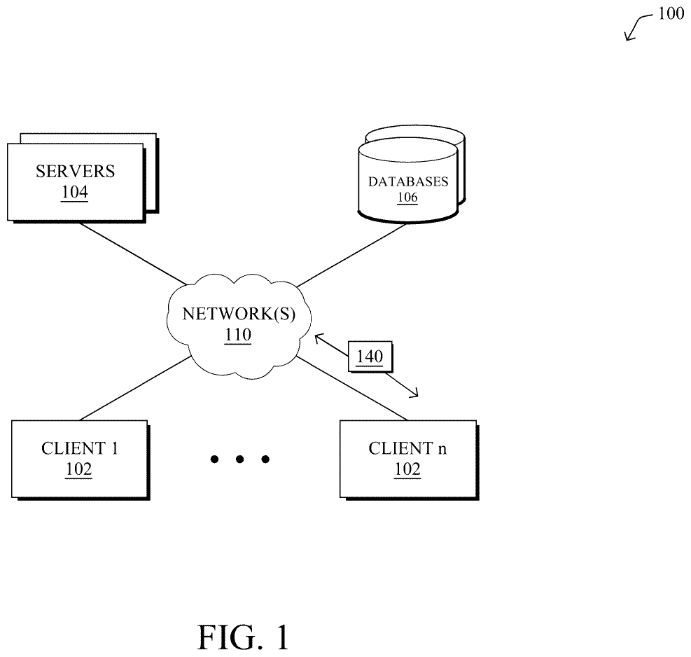

FIG. 1 illustrates an example computing system;

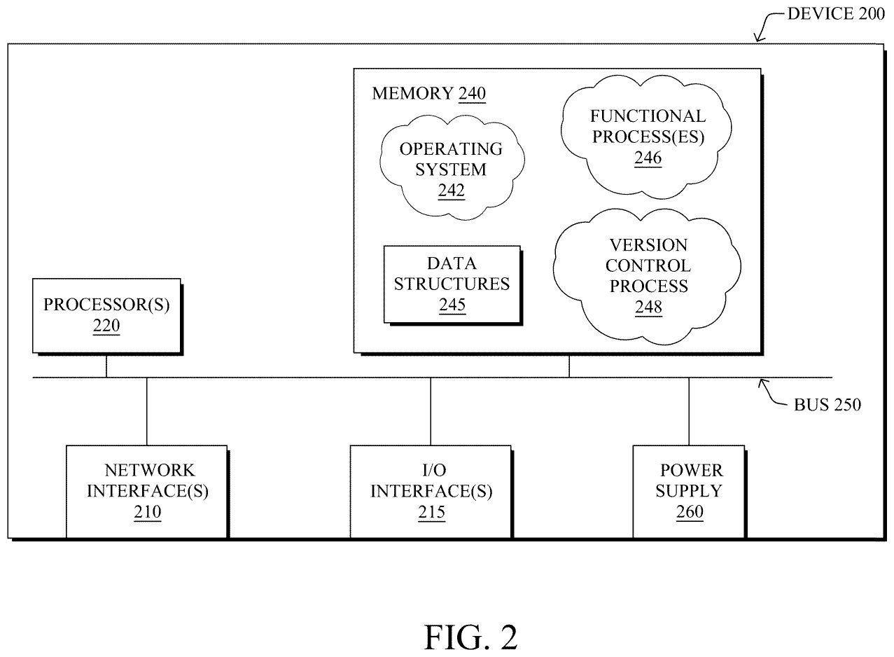

FIG. 2 illustrates an example network device/node;

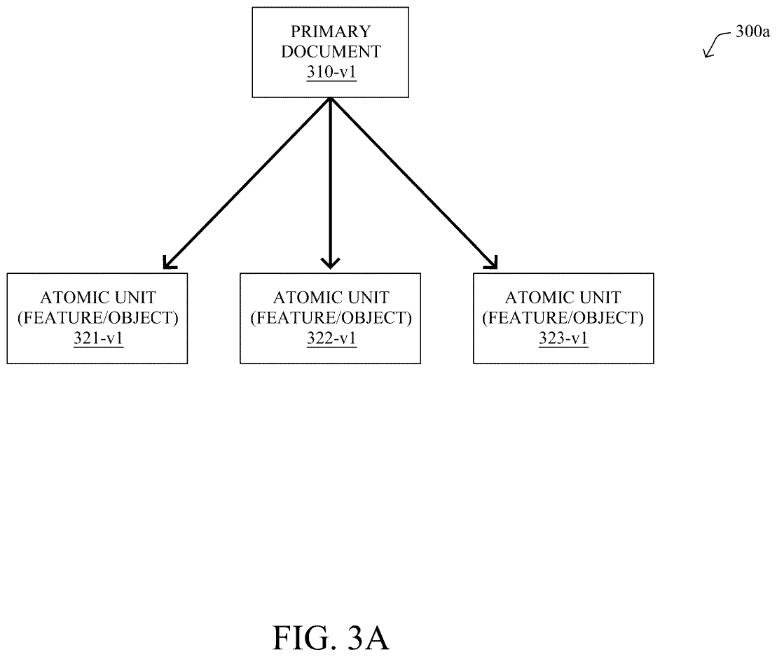

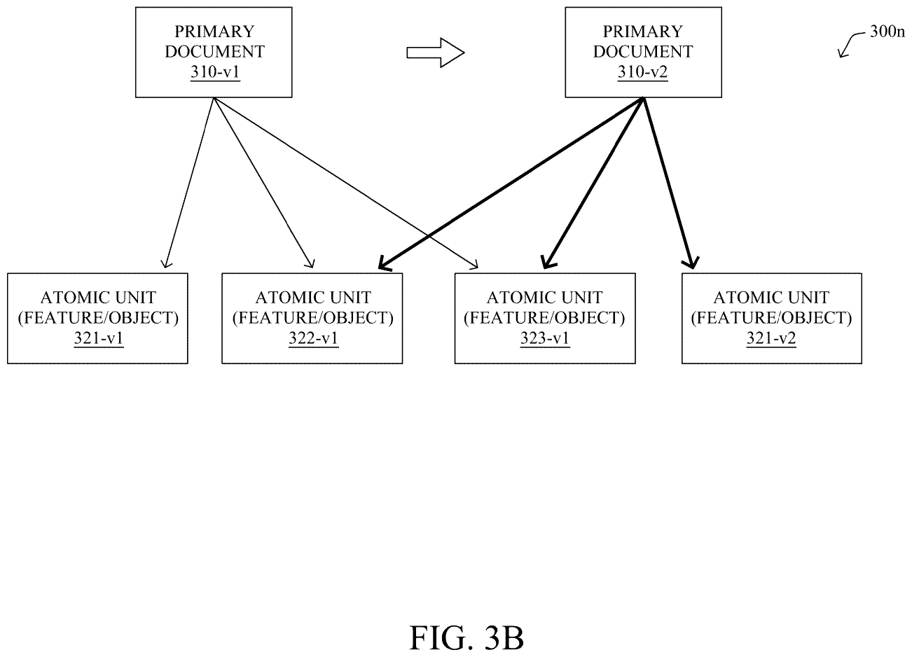

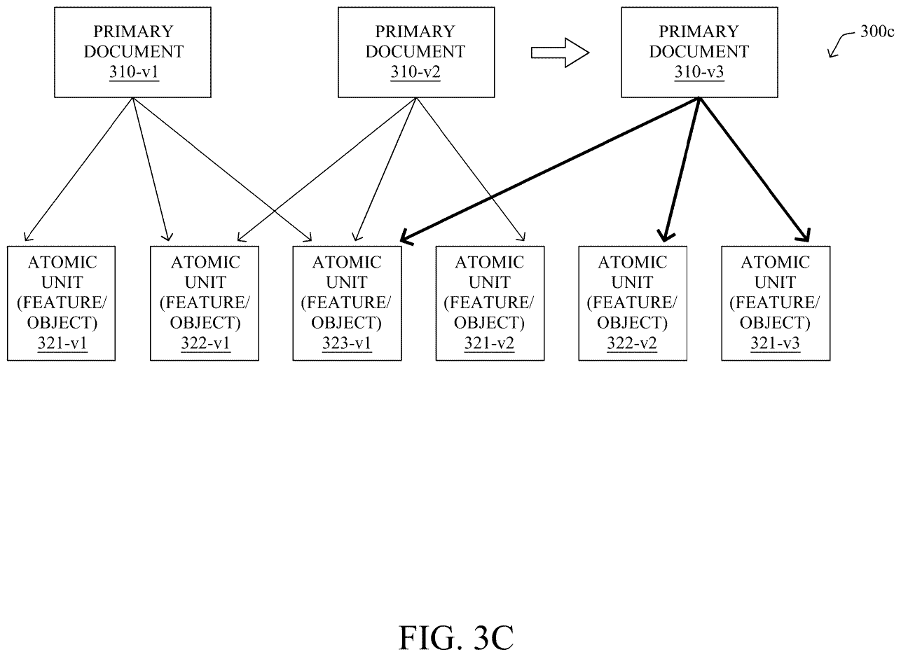

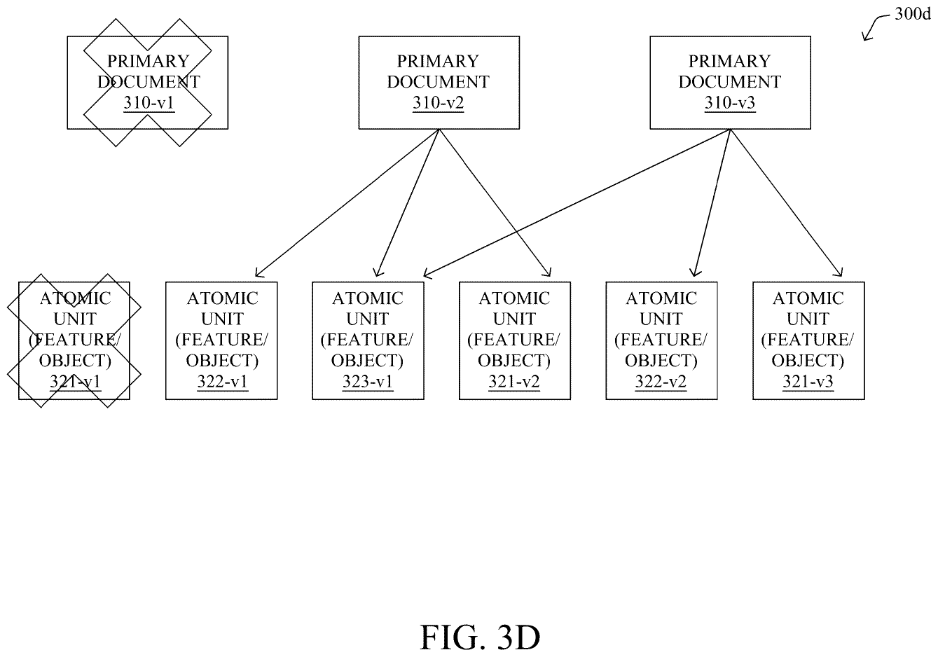

FIGS. 3A-3D illustrate an example of version control for structured network configuration data;

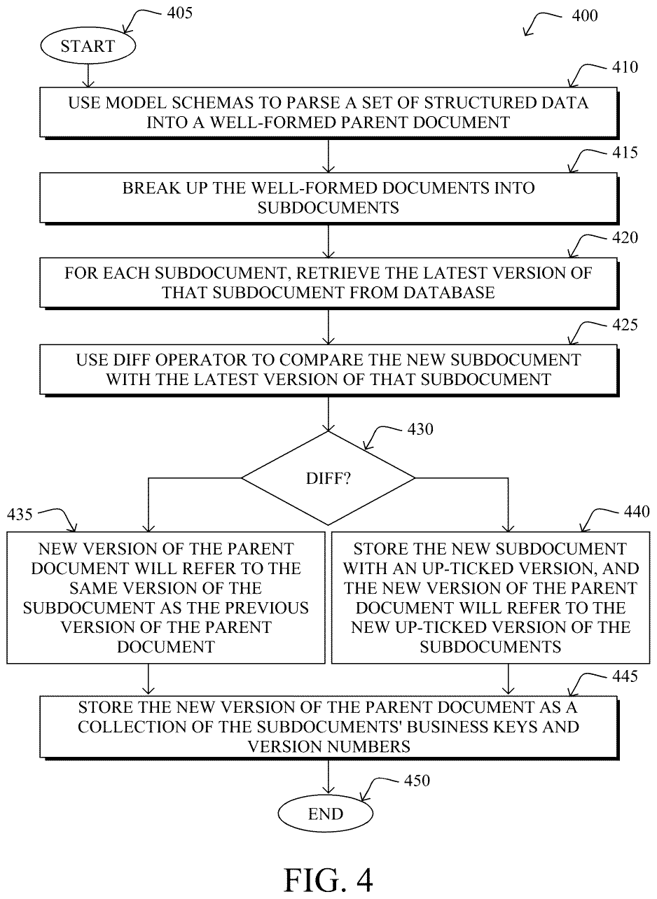

FIG. 4 illustrates an example procedure for committing a new version of a document;

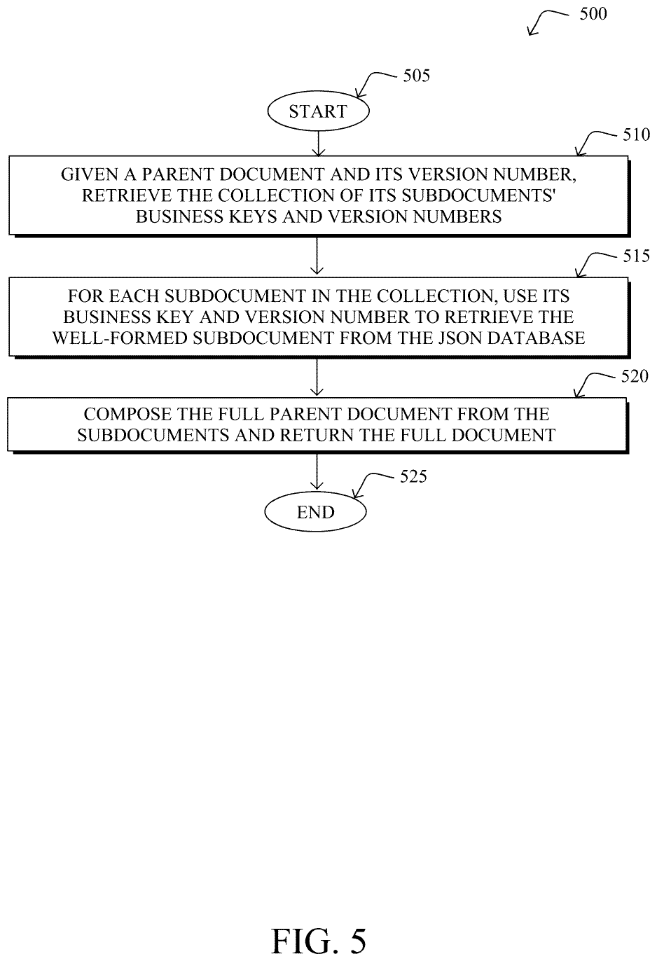

FIG. 5 illustrates an example procedure for retrieving a version of a document;

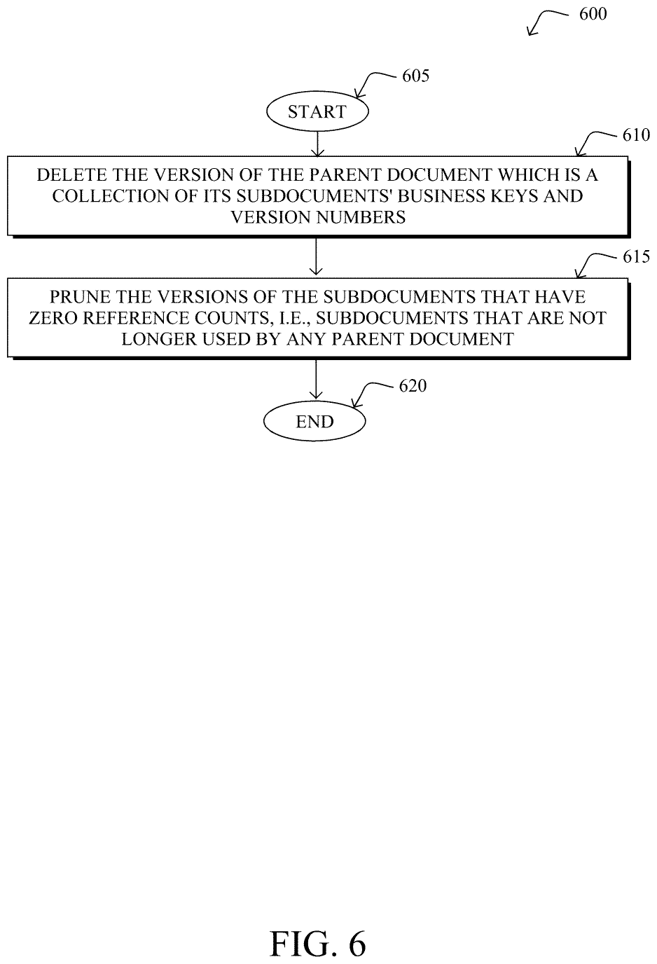

FIG. 6 illustrates an example procedure for deleting a version of a document;

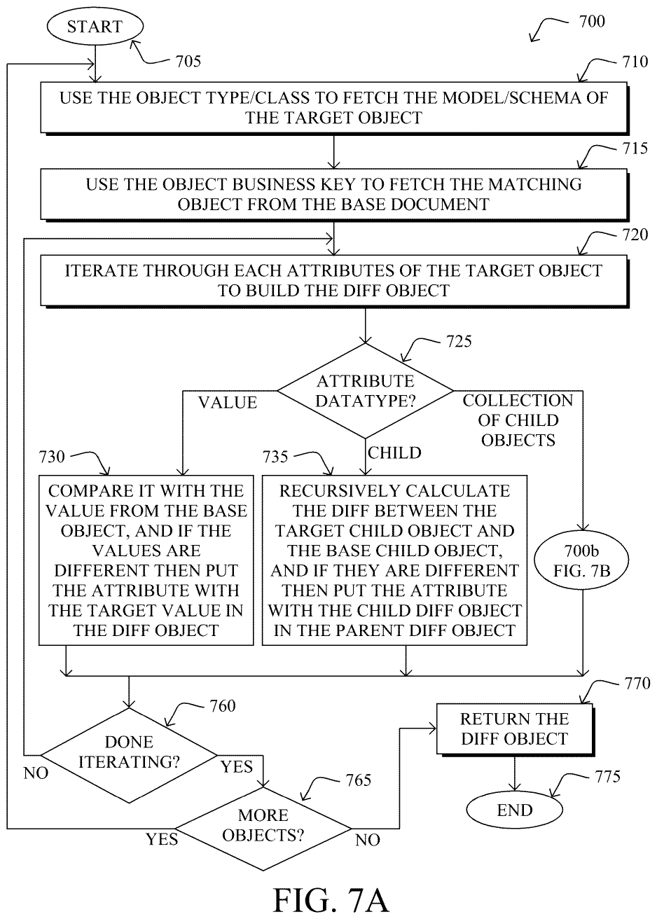

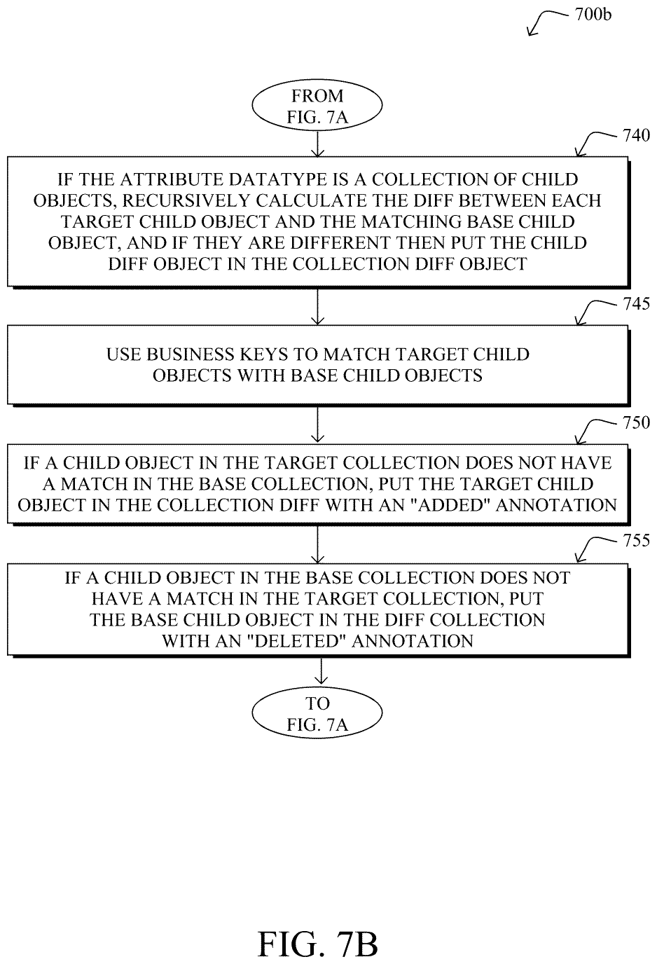

FIGS. 7A-7B illustrate an example procedure for calculating the Diff between a target document and a base document;

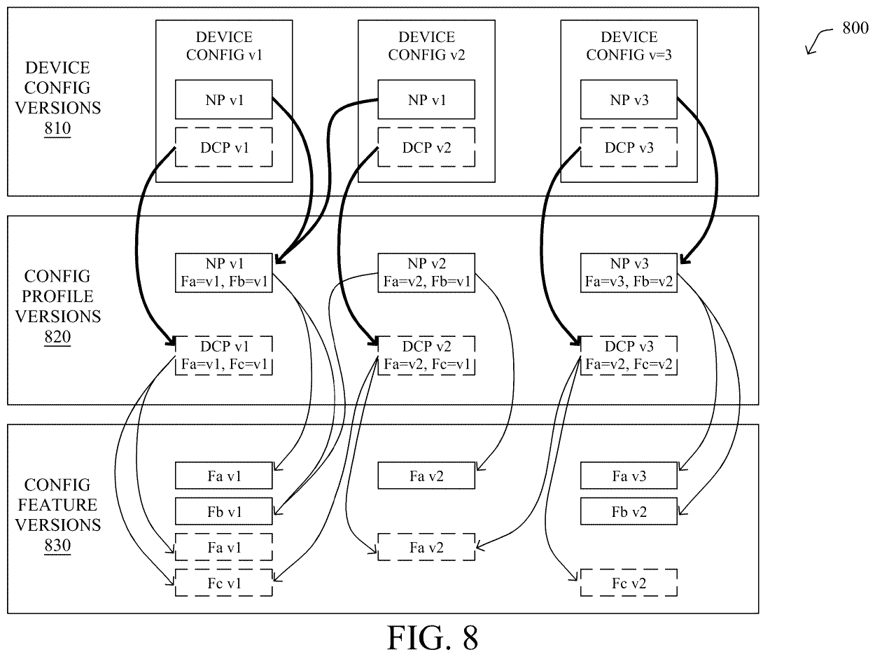

FIG. 8 illustrates an example version control system for network device configurations; and

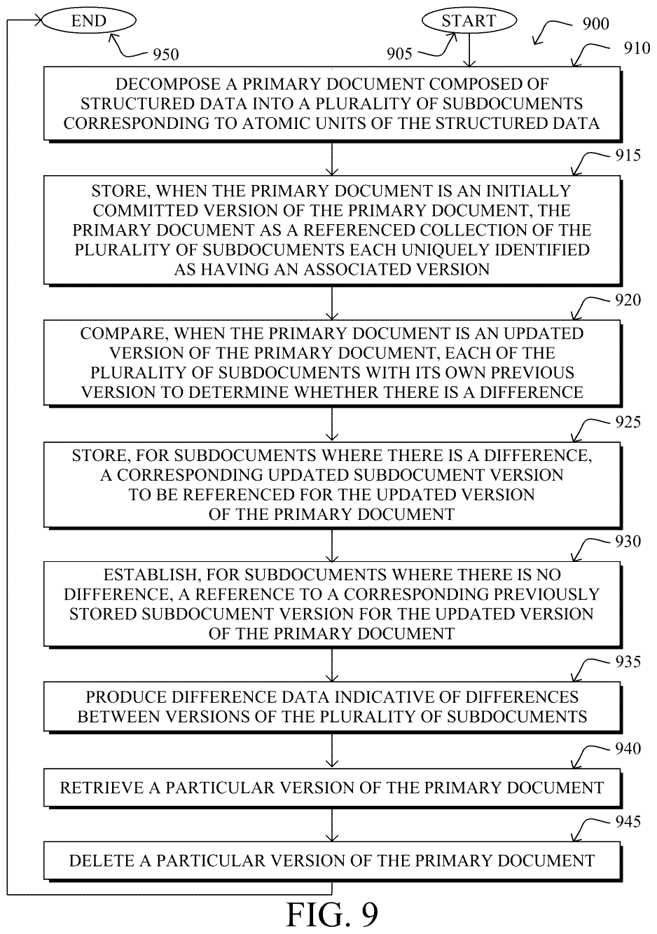

FIG. 9 illustrates an example procedure for version control for structured configuration data according to one or more embodiments of the present disclosure.

### DESCRIPTION OF EXAMPLE EMBODIMENTS

### Overview

According to one or more embodiments of the disclosure, version control for structured configuration data is provided. In particular, in one embodiment, an illustrative method herein comprises: decomposing a primary document composed of structured data into a plurality of subdocuments corresponding to atomic units of the structured data; storing, when the primary document is an initially committed version of the primary document, the primary document as a referenced collection of the plurality of subdocuments each uniquely identified and having an associated version; comparing, when the primary document is an updated version of the primary document, each of the plurality of subdocuments with its own previous version to determine whether there is a difference; storing, for subdocuments where there is a difference, a corresponding updated subdocument version to be referenced for the updated version of the primary document; and establishing, for subdocuments where there is no difference, a reference to a corresponding previously stored subdocument version for the updated version of the primary document.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a version control process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### ——Version Control for Structured Configuration Data——

As noted above, the complexity of computer systems and networks is increasing, as well as the associated configuration data. Large numbers of configuration parameters are typically organized in complex structures of interconnected model objects that change frequently as the networks adapt to dynamic loads and environments, and as new protocols and products are continuously released. As also noted, managing and tracking the voluminous configuration changes is difficult and lacks a scalable solution for the sheer size of these configuration files.

Moreover, existing version control systems are not suitable for structured data such as network and device configurations. Instead, these systems are designed for textual data (e.g., unstructured) such as software source codes and other text documents and are not optimal to manage structured data such as hierarchical configurations that are composed of large numbers of config objects inter-connected in various directed graphs.

The techniques herein, therefore, provide for version control for structured configuration data. In particular, the techniques herein presents a model-based version control system that can track changes and manage versions of complex structured documents (e.g., complex network configurations) with high scalability and performance, capable of scaling to billions of configuration parameters soon to be found in large enterprise networks.

Specifically, according to one or more embodiments of the disclosure as described in detail below, an illustrative method herein comprises: decomposing a primary document composed of structured data into a plurality of subdocuments corresponding to atomic units of the structured data; storing, when the primary document is an initially committed version of the primary document, the primary document as a referenced collection of the plurality of subdocuments each uniquely identified and having an associated version; comparing, when the primary document is an updated version of the primary document, each of the plurality of subdocuments with its own previous version to determine whether there is a difference; storing, for subdocuments where there is a difference, a corresponding updated subdocument version to be referenced for the updated version of the primary document; and establishing, for subdocuments where there is no difference, a reference to a corresponding previously stored subdocument version for the updated version of the primary document. In further embodiments described herein, the method further comprises one or more of: producing difference data indicative of differences between versions of the plurality of subdocuments; retrieving a particular version of the primary document; and deleting a particular version of the primary document.

Notably, the embodiments herein are described in accordance with structured data in JavaScript Object Notation (JSON) format, but the same processes can be used for other structured data formats, such as extensible Markup Language (XML), among others, and JSON is not meant to be limiting to the scope of the present disclosure, and should merely be considered an example implementation. Furthermore, while network configurations are used as a primary example of large structure data files/documents, other types of configurations, or other files/documents with structured data generally, may take advantage of the version control techniques herein.

Operationally, and as described in greater detail below, the techniques herein illustratively use data models to parse and transform configuration data into well-formed JSON documents. A specialized “JSON Diff operator” is defined herein to calculate the differences between two well-formed JSON documents. Unlike traditional text-based comparison tools like the Linux “diff” command, the JSON Diff operator herein is designed to use data models to properly accommodate structured data and polymorphism effectively.

To manage the complexity of large well-formed JSON documents, the system herein breaks (decomposes) them into smaller well-formed subdocuments. This “divide and conquer” approach normalizes the structured data into a standard format, making the system flexible enough to accommodate device-specific variations (e.g., with certain features being agnostic/uniform across devices, while other certain features can remain device-specific). Notably, each subdocument may represent an atomic unit of the structured data, such as a “feature”. In some embodiments, the subdocuments may be organized hierarchically into tiers or levels, such as high-level configuration, configuration profiles, and configuration features, as described below. (In this instance, for example, certain components within middle tiers/levels may remain as references, pointers, or containers, until reaching the lowest level of decomposition, e.g., actual JSON features).

Each well-formed document/subdocument is assigned a business key that uniquely identifies that document/subdocument among other documents/subdocuments within a given context/name space. All documents/subdocuments are versioned independently, i.e., each well-formed document and subdocument has its own versions. Each version of a “leaf” subdocument is stored separately in a JSON database, indexed by the business key of the subdocument and the version number. A version of the parent document is stored as a collection of the business keys of its subdocuments and their version numbers. That is, parent document versions reference associated subdocuments by their business keys and version numbers, enabling two or more versions of a parent document to share the same stored version of a subdocument, thus avoiding redundant storage.

As also described in greater detail below, the system herein supports processes for committing new versions of well-formed documents using the above components, retrieving specific versions of well-formed documents using the above components, calculating differences between versions of well-formed documents (e.g., using the JSON Diff operator), and merging branches of well-formed documents.

FIGS. 3A-3D illustrate an example of version control for structured network configuration data, the details of which as described in greater detail below. In particular, version control begins in scenario 300a of FIG. 3A by obtaining a versioned primary document of structured data, primary document 310-v1 (version 1), which is then decomposed into smaller “atomic units” of the structured data, such as individual features or JSON objects, such as according to a model schema. As shown, such atomic units may include atomic unit 321-v1 (version 1 of atomic unit 321), atomic unit 322-v1 (version 1 of atomic unit 322), and atomic unit 323-v1 (version 1 of atomic unit 323). These may be stored in a database, such as a JSON database, for comparison and to compose the primary documents as described below. Note that while only three atomic units are shown in this simplified illustration, as mentioned above such primary documents may be network configuration files with millions or billions of such atomic units, and the view shown herein is meant for illustration only.

Assume now that version control moves to scenario 300b of FIG. 3B when an updated version of the primary document, now becoming primary document 310-v2 (version 2), is obtained. At this time, the primary document 310-v2 is decomposed into its atomic units, and those are compared to the previous corresponding versions (e.g., a “Diff” operation to find the differences from the previous version, as described in greater detail below). As shown, further assume that the only update was to atomic unit 321 (to atomic unit 321-v2, version 2). According to the techniques herein, the primary document 310-v2 may thus reference the original shared atomic units, atomic unit 322-v1 (version 1 of atomic unit 322) and atomic unit 323-v1 (version 1 of atomic unit 323), and only a new version of atomic unit 321 needs to be stored (atomic unit 321-v2, version 2). Note that the primary document 310-v1 (version 1) still exists and references its atomic units as described above in scenario 300a. As such, the system herein is now storing two versions of the primary document, but in an efficient manner by only having added reference pointers and one new atomic unit. In order to generate version 2 of the primary document 310-v2, the techniques herein may consequently “merge” the new atomic units with the previous atomic units as referenced for the primary document 310-v2, and the entirety of the primary document 310-v2 need not be stored (i.e., only the differences need to be stored).

The process of updating the primary document may continue, such as shown in scenario 300c of FIG. 3C, where a third version of the primary document 310-v3 is obtained, this time updating atomic unit 321 again (to atomic unit 321-v3, version 3), and also atomic unit 322 (to atomic unit 322-v2, version 2). According to the techniques herein, after decomposing the primary document 310-v3 and determining the updated (different) atomic units, the primary document 310-v3 may thus reference any previous shared (not updated) atomic units, atomic unit 323-v1 (version 1 of atomic unit 323), and new versions of atomic unit 321 and atomic unit 322 need to be stored (that is, atomic unit 321-v3, version 3, and atomic unit 322-v2, version 2).

This process may continue as needed, where only changes from the previous versions of the primary document (e.g., updates to network configuration parameters) need to be stored. While the simplified example shown may not demonstrate true efficiencies afforded by the techniques herein, it is important to note that when a small fraction of the millions of objects of a JSON configuration file is updated, the techniques herein provide significant advantages in terms of storage and in terms of bandwidth (e.g., only sending the updated objects to devices to update their configurations).

Note also that the techniques herein allow for rolling back to any previous version by simply generating a complete versioned primary document by composing the correspondingly references atomic units. For example, even though the latest version in the scenario 300c above is version 3, returning to version 2 or version 1 is as simple as regenerating the appropriate versioned primary document in the same manner as the latest version would be generated—by composing those atomic units referenced by the desired version of the primary document.

Furthermore, as shown in scenario 300d of FIG. 3D, older versions of the primary document may be deleted, such as version 1 (primary document 310-v1). When this happens, the techniques herein may determine whether any atomic unit versions no longer have any referencing primary documents, such as atomic unit 321-v1, and appropriate “garbage collection” may commence (for instance, also deleting atomic unit 321-v1, as no other primary document still references it). The other “version 1” atomic units, namely, atomic unit 322-v1 and atomic unit 323-v1, are both maintained in storage, as at least one existing primary document still references them.

Note that according to one or more aspects of the present disclosure as noted above, the techniques herein are based on structured data, and in one specific implementation, on well-formed JSON documents. (Those skilled in the art of JSON will appreciate that a “well-formed JSON document” means document that strictly conforms to proper JSON formatting and grammar, adhering to specific principles.) All features (e.g., JSON objects) in a well-formed document should (e.g., must, in one embodiment) have an annotation to specify the type/class of the feature (or object), unless the type/class can be derived from the context. Features (e.g., JSON objects) in the document may have a business key that uniquely identifies the object among the other objects in the same collection/context. Each feature or object type/class must have a defined Model Schema which specifies the attributes and their cardinalities and data types of the feature/object. (Note that the term “attribute” herein refers to a property of a feature/object in a document.)

Additionally, each document should (e.g., must) have a Model Schema which specifies the objects in the document and how the objects are inter-connected. That is, by outlining the relationships between objects, such as root objects and child objects, in the model schema, the techniques herein ensure that the document structure is clearly defined and maintained. Note that the term “child object” refers to an object that is either a property of another object (parent object) or an element in an array property of a parent object. The term “root object” refers to an outermost object in a JSON document, i.e. an object that is not a child of any other object.

FIG. 4 illustrates an example procedure (procedure 400) for committing a new version of a document (similar to scenario 300a of FIG. 3A above). In operation, an illustrative process of committing a new version of a document starts in step 405, and continues to step 410 to first use Model Schemas to parse a set of structured data (e.g., network configurations or other data) into a well-formed parent document (e.g., a JSON document). In step 415, the process breaks up (decomposes) the well-formed documents into subdocuments, then in step 420, for each subdocument, the process retrieves the latest version of that subdocument from the associated database (e.g., a JSON database). In step 425, the process then uses a Diff operator (e.g., JSON Diff operator) as described below to compare the new subdocument with the latest version of that subdocument.

The procedure 400 is then dependent in step 430 on whether the outcome of step 425 results in a Diff. If there is no diff, then in step 435 the new version of the parent document will refer to the same version of the subdocument as the previous version of the parent document. Else, in step 440 the process stores the new subdocument with an up-ticked version, and the new version of the parent document will refer to the new up-ticked version of the subdocuments.

In step 445 the process stores the new version of the parent document as a collection of the subdocuments' business keys and version numbers. The procedure 400 for committing a new version of a document may then end in step 450.

FIG. 5 illustrates an example procedure (procedure 500) for retrieving a version of a document. In particular, an illustrative process of retrieving (fetching) a version of a document starts in step 505, and continues to step 510, where, given a parent document and its version number, the process retrieves the collection of its subdocuments business keys and version numbers. Then in step 515, for each subdocument in the collection, the process uses its business key and version number to retrieve the well-formed subdocument from the associated database (e.g., the JSON database). In step 520, the process may then compose the full parent document from the subdocuments and return the full document, accordingly, and the process ends in step 525.

FIG. 6 illustrates an example procedure (procedure 600) for deleting a version of a document (similar to scenario 300d of FIG. 3D above). For instance, an illustrative process of deleting a version of a document may start in step 605, and continues to step 610, where the process deletes the version of the parent document which is a collection of its subdocuments business keys and version numbers. Then, in step 615, the process may prune the versions of the subdocuments that have zero reference counts, i.e., subdocuments that are no longer used by any parent document, thus ensuring efficient storage management while preserving versions still in use. The procedure 600 may then end in step 620.

FIGS. 7A-7B illustrate an example procedure (procedure 700) for calculating the Diff between a target document and a base document (e.g., a “JSON Diff Operator”) (similar to scenario 300b of FIG. 3B and scenario 300c of FIG. 3C above). An illustrative process of calculating the Diff between a target document and a base document may start in step 705 of FIG. 7A from the root object of the target document, and continues to step 710 to use the object type/class to fetch the model/schema of the target object. Then in step 715, the process may use the object business key to fetch the matching object from the base document. In step 720, the process then begins iterating thru each attribute of the target object to build the Diff object.

The procedure 700 is then dependent in step 725 on the particular attribute datatype. If the attribute datatype is a value (such as a string or a number), then in step 730 the process compares it with the value from the base object. If the values are different then it puts the attribute with the target value in the Diff object. If, however, the attribute datatype is a child object, then in step 735 the process recursively calculates the Diff between the target child object and the base child object, and if they are different then the process puts the attribute with the child Diff object in the parent Diff object.

If, however, the attribute datatype is a collection of child objects, then referring to sub-procedure 700b of FIG. 7B, the process recursively calculates the diff between each target child object and the matching base child object, and if they are different then puts the child Diff object in the collection Diff object. In step 745, the process uses business keys to match target child objects with base child objects. If a child object in the target collection does not have a match in the base collection, then in step 750 the process puts the target child object in the collection Diff with an “ADDED” annotation. On the other hand, if a child object in the base collection does not have a match in the target collection, then in step 755 the process puts the base child object in the Diff collection with an “DELETED” annotation. The procedure then returns to FIG. 7A.

Once done iterating attributes in step 760 (else returning to step 725), and once there are no more objects in step 765 (else returning to step 715), then the process, in step 770, returns the Diff object, and the procedure ends in step 775 with the returned Diff object, accordingly.

Notably, the techniques herein also specifically define an illustrative “JSON Diff Patch” format for expressing the differences between two JSON documents. The JSON Diff Patch format is intended for use with a HTTP PATCH method to perform incremental changes to a target JSON resource.

Specifically, JSON Patch (RFC-6902) defines a format to modify JSON documents, where a JSON Patch consists of an array of patch operations to be applied to a target document (thus a JSON Patch document does not have the same structure as the target JSON document). In addition, JSON Patch supports patching arrays but not concurrently. For example, if a user inserts an element to an array at index 1 when a second user is concurrently updating the element at index 2, then the second user may get the wrong element updated. More recently, JSON Merge Patch (RFC-7396) defines a patch document format that closely mimics the structure of the target JSON document, but JSON Merge Patch does not support patching arrays incrementally. To change an element in an array, the entire array needs to be sent in JSON Merge Patch. This is particularly problematic in network configurations where there are many large arrays containing thousands of config objects.

In comparison, the newly defined JSON Diff Patch (or “JSON-Diff”) supports incremental and concurrent updates to arrays, and follows the same hierarchical structure of the target JSON document. The techniques herein utilize a set of operators embedded in JSON trees to annotate changes to be made to the target document. Given today's large and complex network configurations, having a robust change management system that supports multi-user concurrent and incremental changes is a valuable asset.

For example, given the following simplified target JSON document which describes a network device's VLAN configurations:

```
{
  “deviceId”: “switch-101”,
  “vlanConfigs”: [
    {
      “vlanId”: 10,
      “name”: “DATA VLAN”,
      “shutdown”: false
    },
    {
      “vlanId”: 20,
      “name”: “VOICE VLAN”,
      “shutdown”: true
    },
    {
      “vlanId”: 30,
      “name”: “LAB VLAN”,
      “shutdown”: true
    }
  ]
}
```

Changing the name of VLAN 20, removing VLAN 30 and adding VLAN 40 can be achieved by sending the following JSON Diff Patch document:

```
PATCH https://example.org/device/configs
Content-Type: application/diff-patch+json
{
  “deviceId”: “switch-101”,
  “vlanConfigs”: [
    {
      “vlanId”: 20,
      “name”: “MEDIA VLAN”
    },
    {
      “@op”: “remove”,
      “vlanId”: 30,
    },
    {
      “@op”: “add”,
      “vlanId”: 40,
      “name”: “TEST VLAN”
    }
  ]
}
```

It is worth noting that the “schema-aware” Diff herein uses object schemas (e.g., JSON-Schema and/or OpenAPI schemas) to traverse the JSON object graph and perform more intelligent Diff. In particular, the techniques herein use schemas to determine object types (classes) and which object attributes should be used to pair objects when comparing two collections/sets of objects. For example, when comparing two sets of objects, previous techniques (e.g., RFC-7396) are not aware of object types and identifications, and thus cannot perform granular pair-wise object Diff. As a result, Diff operations from such previous techniques (e.g., RFC-7396) will include the entire set, even if only a few child elements of the set are changed. The techniques herein, on the other hand, based on the schema-aware Diff, will narrow down to the child objects/attributes that are changed, which results in a more compact and efficient Diff.

In one embodiment, a JSON Diff document is a JSON document in which a JSON object may contain a “@type” and an “@op” annotation to specify the type of the object and the patch operation to be applied to the target document.

That is, tach JSON object may contain a “@type” annotation which specifies the type or class of the object. For example, a VLAN configuration can be represented by the following object:

```
{
  “@type”: “Network Vlan”,
  “vlanId”: 20,
  “shutdown”: true
}
```

The “@type” annotation is optional. The object type may be implied given the local context of the object in the document. For example, all objects in the illustrative VLAN configuration section may implicitly have the same type of “Network Vlan”.

Also, each object type may have an OpenAPI schema that specifies the object attribute(s) that constitutes the object identification key (OIK) that uniquely identifies the object among other objects of the same type in the local context of the document. Note that the OIK does not need to be globally unique, just unique against other OIKs within its domain/name-space.

For example, the OpenAPI schema for “Network Vlan” may specify that the “vlanId” attribute is the OIK that uniquely identifies a Network VLAN object among other NetworkVLAN objects in the local context, i.e. the set of VLANs in a network device.

The following OpenAPI schema illustrates the “Network Vlan” object type and its OIK (uniqueKey):

```
{
  ″$id″: ″https://example.org/NetworkVlan.schema.json″,
  ″$schema″: ″https://json-schema.org/draft/2020-12/schema″,
  ″type″: ″object″,
  ″uniqueKey″: [″vlanId″],
  ″properties″: {
    ″@type″: {
    ″const″: ″Network Vlan″
    },
    ″vlanId″: {
      ″type″: ″integer″
    },
    ″name″: {
      ″type″: ″string″
    },
    ″shutdown″: {
      ″type″: ″boolean″
    }
  }
}
```

An object in a JSON document is identifiable if it has an object type, either implicitly or explicitly with “@type”, and the object type has an OIK defined. Additionally, any singleton object, i.e., an object that does not have other objects of the same type in the local context of the JSON document is also identifiable.

Note that a JSON Diff document and its target document may contain identifiable objects as well as non-identifiable object. For example, a Date object which represents a calendar date is not an identifiable object if a JSON document contains multiple Date objects which may have the same date value.

Regarding, patch operations, each identifiable object in a JSON Diff Patch document may contain a “@op” annotation to specify the patch operation to apply to the target JSON document. The value of an “@op” annotation should be one of “merge”, “replace”, “remove”, or “add”. Patching a target document using JSON Diff Patch may be performed by traversing the JSON Diff Patch document recursively, starting from the root object. For each identifiable object in the patch document, the corresponding identifiable object in same local context of the target JSON document is added, removed, updated, or replaced according to the “@op” annotation specified in the patch object. The semantics of each patch operation is defined below.

First, the “merge” operation merges a patch object with the corresponding object in the target document.
If a target object with the same OIK as the patch object already exists in the same local context in the target document, then the patch object is merged with the target object. If the patch object and the target object have two different values for the same attribute, the merged object must take the value from the patch object.
If a target object with the same OIK as the patch object does not exists in the same local context in the target document, then the patch object is added to the target document.

For example, given the following target document, where “id” is the OIK of the objects in the array “b”:

```
{ ″a″: 1,
  ″b″: [
    { ″id″: ″B1″,
      ″c″: 1
    },
    { ″id″: ″B2″,
      ″c″: 2
    }
  ]
}
```

and the following JSON Diff Patch:

```
{ ″@op″: ″merge″,
  ″b″: [
    { ″@op″: ″merge″,
      ″id″: ″B1″,
      ″d″: 0,
    },
    { ″@op″: ″merge″,
      ″id″: ″B2″,
      ″c″: 0,
    }
  ]
}
```

the patched document will be:

```
{ ″a″: 1,
  ″b″: [
    { ″id″: ″B1″,
      ″c″: 1,
      ″d″: 0
    },
    { ″id″: ″B2″,
      ″c″: 0
    }
  ]
}
```

The “merge” operation is the default operation if an object does not have an operation specified. For example, the above JSON Diff Patch can be written as:

```
{
  ″b″: [
    {
      ″id″: ″B1″,
      ″d″: 0,
    },
    {
      ″id″: ″B2″,
      ″c″: 0,
    }
  ]
}
```

Next, the “replace” operation replaces an object in the target document with the patch object:
If a target object with the same OIK as the patch object already exists in the same local context in the target document, then the target object is replaced with the patch object.
If a target object with the same OIK as the patch object does not exists in the same local context in the target document, then the patch object is added to the target document.

For example, given the same target document above, the following JSON Diff Patch:

```
{
  ″b″: [
    { ″@op″: ″replace″,
      ″id″: ″B2″,
      ″d″: 0,
    }
  ]
}
```

will result in:

```
{ ″a″: 1,
  ″b″: [
    { ″id″: ″B1″,
      ″c″: 1
    },
    { ″id″: ″B2″,
      ″d″: 0
    }
  ]
}
```

In addition, the “remove” operation removes an object from the target document:
If a target object with the same OIK as the patch object already exists in the same local context in the target document, then the target object is removed from the target document.
If a target object with the same OIK as the patch object does not exists in the same local context in the target document, then no operation is performed.

For example, given the same target document above, the following JSON Diff Patch:

```
{
  ″b″: [
    { ″@op″: ″remove″,
      ″id″: ″B2″,
    },
    { ″@op″: ″remove″,
      ″id″: ″B3″,
    }
  ]
}
```

will result in:

```
{ ″a″: 1,
  ″b″: [
    { ″id″: ″B1″,
      ″c″: 1
    }
  ]
}
```

Lastly, the “add” operation adds or replaces an object in the target document:
If a target object with the same OIK as the patch object does not exist in the same local context in the target document, then the patch object is added to the target document.
If a target object with the same OIK as the patch object already exists in the same local context in the target document, then the object in the target document is replaced with the patch object.

For example, given the same target document above, the following JSON Diff Patch:

```
{
  ″b″: [
    { ″@op″: ″add″,
      ″id″: ″B2″,
      ″d″: 0
    },
    { ″@op″: ″add″,
      ″id″: ″B3″,
      ″d″: 0
    }
  ]
}
```

will result in:

```
{ ″a″: 1,
  ″b″: [
    { ″id″: ″B1″,
      ″c″: 1
    },
    { ″id″: ″B2″,
      ″d″: 0
    },
    { ″id″: ″B3″,
      ″d″: 0
    }
  ]
}
```

Notably, if an operation is specified for a parent object, the same operation may cascade to all child objects of the parent object by default, except when a child has its own operation specified, wherein the child's operation will override the parent's operation. For example, the following JSON Diff Patch

```
  { ″@op″: ″merge″,
    ″a″: 1,
    ″b″: [
    {
      ″id″: ″B1″,
      ″d″: 0,
    },
    { ″@op″: ″remove″,
      ″id″: ″B2″,
    }
  ]
}
```

is equivalent to:

```
{ ″@op″: ″merge″,
  ″a″: 1,
  ″b″: [
    { ″@op″: ″merge″,
      ″id″: ″B1″,
      ″d″: 0,
    },
    { ″@op″: ″remove″,
      ″id″: ″B2″
    }
  ]
}
```

In certain embodiments herein, the “remove” and “replace” operations are not overridable. For example, if a parent object is removed, all its child objects will also be removed, and thus the child objects should not have any “@op” other than “remove”. Similarly, if a parent object is replaced, all its child objects will be replaced by the child objects of the replacing parent. For example, given the same target document above, the following JSON Diff Patch:

```
{ ″@op″: ″replace″,
  ″a″: 1,
  ″b″: [
    {
      ″id″: ″B1″,
      ″d″: 0
    }
  ]
}
```

will result in:

```
{
  ″a″: 1,
  ″b″: [
    {
      ″id″: ″B1″,
      ″d″: 0
    }
  ]
}
```

Regarding concurrent patches and conflict detections herein, multiple users could use JSON Diff to patch the same document concurrently. If two users patch different identifiable objects of the same document, their patches are not conflicting, and the result is not affected by the ordering of the patches. If two users patch the same identifiable objects in a document with conflicting changes, the one patch will overwrite the other one.

Conflicting concurrent patches may be detected and prevented by using document versions. Each JSON document may have a version number that is automatically incremented by one every time the document is patched or otherwise updated. A user should GET the current version number of a document and send back the version number in the PATCH request. If the server receives a PATCH request whose version number is smaller than the current version number of the document, the server could determine if the patch request is conflicting with the previous patch request and return an error if so. Upon receiving such error, the user should resend the GET request to get the latest version of the document before retrying the PATCH request.

In addition to PATCH requests, a server may accept “DIFF” requests to calculate the differences between two JSON documents. A DIFF operation takes two input JSON documents and returns a JSON Diff Patch document. A server may implement DIFF requests using HTTP GET or POST method. The PATCH and DIFF operations together constitute an algebra over the set of all JSON documents. Implementations of PATCH and DIFF operations should satisfy the following algebraic properties:

$$A + \{ \} = A$$

$$A - A = \{ \}$$

$$A + ( B - A ) = B$$

$$A + ( \{ \} - A ) = \{ \}$$

### Where:

“+” denotes the PATCH operation, wherein the first operand is a target JSON document, and the second operand is a JSON Diff Patch document;
“−” denotes the DIFF operation between two JSON documents;
“A”, “B” and “C” are any JSON documents;
“{ }” is the empty JSON document; and
“=” is the equivalent relationship among JSON documents. Two JSON documents are equal if they have the same set of attributes, and the value of their attributes are equal.

As a demonstration of the techniques herein within an embodiment directed to network configuration data, FIG. 8 illustrates an example version control system (example 800) for network device configurations, accordingly. As shown, configurations of a network device are stored in a “Device Config” well-formed document. Each version of a Device Config document (device config versions 810, namely v1-v3 as shown) represents a “snapshot” of the device configurations at a specific time.

Each Device Config document illustratively has two Config Profile subdocuments: a Network Profile (NP), which stores common configs across a network, and a Device Customization Profile (DCP), which store configurations specific to the device. Each Config Profile subdocument (NP/DCP) has its own versions (config profile versions 820). The business key of a Config Profile is the profile ID.

Each Config Profile subdocument (NP/DCP) in turn comprises of multiple Config Feature subdocuments. Each Config Feature subdocument, such as VLAN configs, has its own version (config feature versions 830). The business key of a Config Feature comprises of the profile ID and the feature name.

Notably, FIG. 8 also illustrates the concept herein of hierarchical (e.g., tiered, layered, etc.) subdocuments beyond what was illustrated in FIGS. 3A-3D above. That is, as opposed to a flat hierarchy of atomic units, the techniques herein may have subdocuments that can be broken down into further subdocuments, such as a tree structure with branches (e.g., groups, categories, profiles, etc.) and leaves (atomic units) within those branches.

Returning to the example, for instance, DCP versions 1 and 2 share the same version 1 for Feature “Fc” but they have their own versions for Feature “Fa”. This reduces storage space as it avoids storing duplicated data across versions.

NP version 2 as shown is not referenced by any Device Config version and is thus eligible for pruning. Once NP v2 is pruned, Fa v2 will in turn have a zero reference count and is also eligible for pruning.

Accordingly, the techniques herein allow network automation applications to easily manage and track config changes for large-scale Enterprise networks with thousands of devices, where each device may have thousands to millions of config parameters per version. Moreover, the Diff operation also enables network admins to easily review network config change history and examine/audit config changes between any two versions of any device in their network.

In closing, FIG. 9 illustrates an example simplified procedure for version control for structured configuration data in accordance with one or more embodiments described herein. For example, a non-generic, specifically configured device (e.g., device 200, an apparatus) may perform procedure 900 by executing stored instructions (e.g., process 248). The procedure 900 may start at step 905, and continues to step 910, where, as described in greater detail above, the process herein comprises decomposing a primary document composed of structured data into a plurality of subdocuments corresponding to atomic units of the structured data. Note that in one embodiment, the structured data is selected from a group consisting of: configuration data, device configuration data, and network configuration data, among others. In another particular embodiment, the structured data comprises a well-formed JavaScript Object Notation (JSON) document.

As noted above, decomposing may be based on a model schema. For instance, the structured data may comprise annotations to identify how to apply the model schema to the structured data, such as when the structured data corresponds to JSON objects, the annotations may comprise type and class indicators. In another embodiment, the process comprises determining how to apply the model schema based on a context of the structured data.

As also mentioned above, in certain embodiments, the primary document is further decomposed into one or more hierarchical layers of organizational subdocuments between the primary document and the plurality of subdocuments corresponding to the atomic units of the structured data. For example, one of the one or more hierarchical layers may comprise a configuration profile layer consisting of at least i) a network profile version subdocument referencing network configuration atomic unit subdocuments, and ii) a device customization profile subdocument referencing device customization atomic unit subdocuments.

Step 915 may comprise storing, when the primary document is an initially committed version of the primary document, the primary document as a referenced collection of the plurality of subdocuments each uniquely identified and having an associated version.

Alternatively, step 920 may comprise comparing, when the primary document is an updated version of the primary document, each of the plurality of subdocuments with its own previous version to determine whether there is a difference. Step 925 may then comprise storing, for subdocuments where there is a difference, a corresponding updated subdocument version to be referenced for the updated version of the primary document. On the other hand, step 930 may comprise establishing, for subdocuments where there is no difference, a reference to a corresponding previously stored subdocument version for the updated version of the primary document.

Additional steps may optionally be included within the procedure 900 to further utilize the version control system herein. For instance, step 935 may comprise producing difference data indicative of differences between versions of the plurality of subdocuments (e.g., and sending the difference data to receiving devices to update their version of the primary document). Note that the difference data may be selected from a group consisting of: attribute values, child object changes, child object additions, and child object deletions, among others.

Also, optional step 940 may comprise retrieving a particular version of the primary document. Specifically, as described above, this may be achieved by determining particular versions of the plurality of subdocuments referenced by the particular version of the primary document; retrieving the particular versions of the plurality of subdocuments; and composing the particular version of the primary document from the particular versions of the plurality of subdocuments.

Further, optional step 945 may comprise deleting a particular version of the primary document, which, as described above, may also comprise pruning one or more corresponding subdocument versions that have no other references from other versions of the primary document after the particular version of the primary document is deleted.

Procedure 900 may end at step 950, notably with the ability to continue updating versions, retrieving versions, deleting versions, and so on, as described herein.

It should be noted that while certain steps within the procedures above may be optional as described above, the steps shown in the procedures above are merely examples for illustration, and certain other steps may be included or excluded as desired.

Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: decomposing a primary document composed of structured data into a plurality of subdocuments corresponding to atomic units of the structured data; storing, when the primary document is an initially committed version of the primary document, the primary document as a referenced collection of the plurality of subdocuments each uniquely identified and having an associated version; comparing, when the primary document is an updated version of the primary document, each of the plurality of subdocuments with its own previous version to determine whether there is a difference; storing, for subdocuments where there is a difference, a corresponding updated subdocument version to be referenced for the updated version of the primary document; and establishing, for subdocuments where there is no difference, a reference to a corresponding previously stored subdocument version for the updated version of the primary document.

In still other implementations, a tangible, non-transitory, computer-readable medium storing program instructions that cause a device to execute a process comprising: decomposing a primary document composed of structured data into a plurality of subdocuments corresponding to atomic units of the structured data; storing, when the primary document is an initially committed version of the primary document, the primary document as a referenced collection of the plurality of subdocuments each uniquely identified and having an associated version; comparing, when the primary document is an updated version of the primary document, each of the plurality of subdocuments with its own previous version to determine whether there is a difference; storing, for subdocuments where there is a difference, a corresponding updated subdocument version to be referenced for the updated version of the primary document; and establishing, for subdocuments where there is no difference, a reference to a corresponding previously stored subdocument version for the updated version of the primary document.

The techniques described herein, therefore, provide for version control for structured configuration data. In particular, the techniques herein provide version control for any structured data (configuration data, network configuration data, etc.), where efficient updates may be made, and previous versions may be maintained for rollbacks in the event of broken or problematic configuration updates. The efficiencies of not storing multiple copies of shared configurations (e.g., a security policy that is shared between two different devices with otherwise different operational configurations) are paramount for maintaining scalability in growing computing systems, with accuracy being achieved by using model-schemas in diffing between structure data documents. The efficient JSON diff herein is particularly useful in high scale systems where large JSONs are used in representing the model, where the techniques herein add custom annotations for efficient processing of what changes happened at the parent, child and leaf levels.

Said differently, the newly defined Diff format herein allows users to send configuration patches in a more compact and user-friendly form than previous techniques. For example, a JSON document that represents the configurations of a Wireless Controller can be as large as 120 MB (more than a million JSON attributes). Having a simple and efficient way to patch such complex documents is advantageous for customers using an API operating with the capabilities described herein to manage their networks.

Illustratively, the techniques described herein may be performed by hardware, software, and/or firmware, (e.g., an “apparatus”) such as in accordance with the version control process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using network configuration data and JSON in particular, other configurations and formats may be used, as noted above.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

1. A method, comprising:
decomposing, by a process, a primary document composed of structured data into a plurality of subdocuments corresponding to atomic units of the structured data;
storing, by the process and when the primary document is an initially committed version of the primary document, the primary document as a referenced collection of the plurality of subdocuments each uniquely identified and having an associated version, the referenced collection comprising, for each subdocument, an identifier of that subdocument and a version number of that subdocument;
comparing, by the process and when the primary document is an updated version of the primary document, each of the plurality of subdocuments with its own previous version to determine whether there is a difference;
storing, by the process and for subdocuments where there is a difference, a corresponding updated subdocument version to be referenced for the updated version of the primary document; and
establishing, by the process and for subdocuments where there is no difference, a reference to a corresponding previously stored subdocument version for the updated version of the primary document.

2. The method of claim 1, further comprising:
producing difference data indicative of differences between versions of the plurality of subdocuments.

3. The method of claim 2, further comprising:
sending the difference data to one or more receiving devices to cause the one or more receiving devices to update a local copy of the primary document to the updated version of the primary document using the difference data.

4. The method of claim 2, wherein the difference data is selected from a group consisting of: attribute values, child object changes, child object additions, and child object deletions.

5. The method of claim 1, further comprising:
retrieving a particular version of the primary document by:
determining particular versions of the plurality of subdocuments referenced by the particular version of the primary document;
retrieving the particular versions of the plurality of subdocuments; and
composing the particular version of the primary document from the particular versions of the plurality of subdocuments.

6. The method of claim 1, further comprising:
deleting a particular version of the primary document; and
pruning one or more corresponding subdocument versions that have no other references from other versions of the primary document after the particular version of the primary document is deleted.

7. The method of claim 1, wherein the primary document is further decomposed into one or more hierarchical layers of organizational subdocuments between the primary document and the plurality of subdocuments corresponding to the atomic units of the structured data.

8. The method of claim 7, wherein one of the one or more hierarchical layers comprises a configuration profile layer consisting of at least i) a network profile version subdocument referencing network configuration atomic unit subdocuments, and ii) a device customization profile subdocument referencing device customization atomic unit subdocuments.

9. The method of claim 1, wherein decomposing is based on a model schema.

10. The method of claim 9, wherein the structured data comprises annotations to identify how to apply the model schema to the structured data, wherein the annotations identify a type or class of for atomic units of the structured data corresponding to the subdocuments, wherein the model schema specifies one or more identification key attributes for the type or class, wherein the identifier of each subdocument in the referenced collection is based on the one or more identification key attributes, and wherein the one or more identification key attributes being used to match corresponding subdocuments between versions.

11. The method of claim 10, wherein the structured data corresponds to JavaScript Object Notation (JSON) objects, and wherein the annotations comprise type and class indicators.

12. The method of claim 9, further comprising:
determining how to apply the model schema based on a context of the structured data.

13. The method of claim 1, wherein the structured data is selected from a group consisting of: configuration data, device configuration data, and network configuration data.

14. The method of claim 1, wherein the structured data comprises a well-formed JavaScript Object Notation (JSON) document.

15. A tangible, non-transitory, computer-readable medium storing program instructions that cause a device to execute a process comprising:
decomposing a primary document composed of structured data into a plurality of subdocuments corresponding to atomic units of the structured data;
storing, when the primary document is an initially committed version of the primary document, the primary document as a referenced collection of the plurality of subdocuments each uniquely identified and having an associated version, the referenced collection comprising, for each subdocument, an identifier of that subdocument and a version number of that subdocument;
comparing, when the primary document is an updated version of the primary document, each of the plurality of subdocuments with its own previous version to determine whether there is a difference;
storing, for subdocuments where there is a difference, a corresponding updated subdocument version to be referenced for the updated version of the primary document; and
establishing, for subdocuments where there is no difference, a reference to a corresponding previously stored subdocument version for the updated version of the primary document.

16. The tangible, non-transitory, computer-readable medium of claim 15, wherein the process further comprises:
producing difference data indicative of differences between versions of the plurality of subdocuments.

17. The tangible, non-transitory, computer-readable medium of claim 16, wherein the process further comprises:
sending the difference data to one or more receiving devices to cause the one or more receiving devices to update a local copy of the primary document to the updated version of the primary document using the difference data.

18. The tangible, non-transitory, computer-readable medium of claim 15, wherein the process further comprises:
retrieving a particular version of the primary document by:
determining particular versions of the plurality of subdocuments referenced by the particular version of the primary document;
retrieving the particular versions of the plurality of subdocuments; and
composing the particular version of the primary document from the particular versions of the plurality of subdocuments.

19. The tangible, non-transitory, computer-readable medium of claim 15, wherein the process further comprises:
deleting a particular version of the primary document; and
pruning one or more corresponding subdocument versions that have no other references from other versions of the primary document after the particular version of the primary document is deleted.

20. An apparatus, comprising:
one or more network interfaces to communicate with a network;
a processor coupled to the one or more network interfaces and configured to execute one or more processes; and
a memory configured to store a process that is executable by the processor, the process comprising:
decomposing a primary document composed of structured data into a plurality of subdocuments corresponding to atomic units of the structured data;
storing, when the primary document is an initially committed version of the primary document, the primary document as a referenced collection of the plurality of subdocuments each uniquely identified and having an associated version, the referenced collection comprising, for each subdocument, an identifier of that subdocument and a version number of that subdocument;
comparing, when the primary document is an updated version of the primary document, each of the plurality of subdocuments with its own previous version to determine whether there is a difference;
storing, for subdocuments where there is a difference, a corresponding updated subdocument version to be referenced for the updated version of the primary document; and
establishing, for subdocuments where there is no difference, a reference to a corresponding previously stored subdocument version for the updated version of the primary document.
